(19) United States
(12) Patent Application Publication
(10) Pub. No.: US 2026/0340888 A1
(43) Pub. Date: Oct. 29, 2026

(54) METHOD FOR COLORIZING AN INFRARED IMAGE

(71) Applicant: LYNRED, Palaiseau (FR)

(72) Inventor: Gabriel Jobert, Veurey-Voroize (FR)

(21) Appl. No.: 19/111,501

(22) PCT Filed: Jun. 30, 2023
(86) PCT No.: PCT/FR2023/051002

§ 371 Date: Mar. 13, 2025

(30) Foreign Application Priority Data
Nov. 14, 2022 (FR) FR2211811

(51) Int. Cl. G06T 11/10

(52) U.S. Cl. CPC G06T 11/10; G06T 2200/24

(57) ABSTRACT

A method of colorizing an infrared image includes acquisition of an infrared image obtained from an infrared sensor that includes a set of elementary detectors. The infrared image includes, for each elementary detector, a pixel having its value coded in grayscale corresponding to a value representing an infrared radiation received by said elementary detector. The method also includes generation of a colorized image by associating to each pixel value coded in grayscale a pixel value coded in a color space by means of a color palette defined in the CIE CAM02-UCS space by a palette generation module using a parametric trajectory in which a parameter is a polar angle vector of the parametric trajectory. The parametric trajectory is defined so that the parametric trajectory projected into a hue and chrominance plane follows one or two ellipses; and a dynamic range of the perceived luminance with respect to the grayscale values follows one or two straight lines.

### TECHNICAL FIELD

The present invention relates to the field of electromagnetic radiation detection and, more specifically, to the infrared radiation detection.

The invention more specifically concerns the issue of the display of an infrared image, that is, an image resulting from the detection of infrared radiation. More particularly, it aims at colorizing an infrared image to improve the interpretation of the infrared image by the human brain.

Thus, the invention may be implemented in many fields for which infrared images are currently used, such as the fields of aerospace, of security, of defense, of transport, of thermography, of industrial inspection, of building inspection, of leisure activities, of health.

### BACKGROUND

In the health field, infrared detectors have widely developed since the COVID-19 pandemics. Indeed, people suffering from this disease conventionally see their temperature rise and infrared detectors enable to obtain an image illustrating the temperature of the objects present in a scene. Thus, infrared detectors are in particular used to identify the temperature of persons penetrating an enclosure to detect whether a person has a high temperature, and thus risks being COVID-19 positive.

Infrared detectors conventionally enable to obtain an image restored in grayscale, in which each pixel represents the quantity of radiation captured by the elementary detectors forming the pixels of the infrared image.

Now, this grayscale representation makes it difficult to visually identify the temperature difference between two objects of a scene having close temperatures.

For example, in the case of the detection of persons with COVID 19, this grayscale representation is often insufficient for an operator to be able to rapidly detect a person having a high temperature in a group of people.

It is thus desired to improve this representation by colorizing the representation of the quantity of radiation captured by the elementary detectors forming the pixels of the infrared image.

This search is in particular motivated by the fact that the human eye can only perceive a limited number of shades of grey, between 120 and 180 shades for a Western person trained according to studies, while a person can perceive up to 2 million colors. Thus, by appropriately selecting the colors, it is possible to significantly improve the perception of the details of an infrared image.

For this purpose, it is known from documents WO 2016/179050, U.S. Pat. No. 10,298,859, or WO 2014/200586 to transform a grey-level infrared image into a colorized image by the application of a color palette. A color palette enables to associate, for each pixel value coded in grayscale, a pixel value coded in a color space.

To define a color space, the scene light spectrum W(λ) is considered in power units, with A the wavelength in micrometers. In the case of a real scene in visible light, W(λ) is the fraction reflected, diffused, or transmitted from the scene illuminated by an external source of given spectral length, preferably a white source, that is, a wide band in the visible range. In the case of a display by a screen, W(λ) is an additive linear combination of the emission spectrums of a triplet of elementary sources, red, green, and blue pixels.

The human eye perceives the luminosity and the color respectively with the rods and cones present in the retina. In low luminosity conditions, typically in scotopic vision, rods provides a unique spectral response. In good luminosity conditions, in photopic vision, cones take part in the perception of color, and are classified according to three families: short, medium, and long, which have distinct spectral responses centered on short, medium, and long wavelengths.

Thus, for the human eye, the color is characterized by a simple scalar triplet, and not a complete scene spectrum. This argument enables to explain how a color can be faithfully rendered via a screen formed of three elementary sources of red, green, and blue spectral lengths.

In the sRGB, for “standard Reg-Green-Blue”, space, a color is represented by the triplet of red, green, and blue colors, generally coded over a depth of three times 8 bits, that is, 24 bits.

To obtain a more precise representation of colors, other spaces have been defined over time. For example, the CIE XYZ space is a coordinate system for the colorimetric space that the International Commission on Illumination (CIE) has defined in 1931. It derives from the SRGB space and postulates that the relations between physical quantities and perception are linear. This approximation places the set of points representative of colors in a three-dimensional vectorial space. To define this CIE XYZ space, colorimetric experiments have been required by asking people to adjust the proportions of three experimentation primary colors so as to obtain a color spot identical to that which had been evaluated. The sum of “X”, “Y”, and “Z” components represents the absolute luminance, but not the luminance really perceived.

The International Commission on Illumination (CIE) has also defined in 1976 the CIE LAB space, based on the CIE XYZ space. It is a colorimetric space particularly used for the characterization of surface colors.

Three quantities characterize the colors: the lightness L, which derives from the luminance of the surface, and two parameters a and b which express the difference of the color with respect to that of a grey surface of same lightness. The existence of a grey, non-colored, achromatic surface, implies explicitly indicating the composition of the light which illuminates the colored surface. This “illuminant” often is the normalized daylight.

The CIE LAB space has the major disadvantage of not correctly modeling the human perception of luminance and hue. In other words, a displacement by an elementary Euclidian length in the CIE LAB space does not necessarily result in a same color perception distance, particularly in terms of luminance and hue. This can be explained by the fact that this model does not take into account the principles of perceptual chromatic adaptation, such as local luminance and hue adaptation.

More recently, in 2002, the International Commission on Illumination (CIE) has defined the CIE CAM02 space to calculate the mathematical correlations existing between the six technical dimensions linked to the appearance of color: luminosity, luminance, colorization, chrominance, saturation, and hue.

This model is defined based on the X, Y, and Z quantities of the CIE XYZ space by taking into account the visualization of a reference stimulus. This stimulus corresponds to a reference white point. The CIE CAM02 model also takes into consideration the background on which the stimulus is observed, information relative to the luminance conditions of the environment of the stimulus, as well as information relative to the taking into account or not of the luminance conditions by the observer of the stimulus. The model enables to predict the appearance of the color of the stimulus with these attributes or to calculate the corresponding color in distinct observation conditions.

There also exist other colorimetric spaces, for example the HSV space, for “Hue-Saturation-Value”, or also the HSL space, for “Hue-Saturation-Luminance”.

For example, document WO 2014/200586 provides a method of generating color palettes based on an interpolation in the HSL space. Based on a series of predefined hue values, the palette is constructed with a constant luminance, a fixed saturation, and a linear interpolation on the hue. According to the type of scene, this method enables to use adapted ranges of hues, for example a red-orange-yellow palette for desert scenes, or a yellow-green-blue palette for wood scenes.

In document WO 2016/179050, color palettes are generated by interpolation in the SRGB space based on a series of base colors, corresponding to interpolation nodes.

Document U.S. Pat. No. 10,298,859 discloses solutions of colorization in the sRGB, CIE XYZ, or CIE LAB space, mainly by using color palettes predefined for specific applications. In an embodiment, a color palette is generated based on the minimum and maximum grayscale values of an infrared image. This color palette is thus adapted to the dynamic range of the observed scene.

Thus, a scene with a low thermal contrast is shown with a low hue dynamic range, which is compensated for by an adapted luminance dynamic range. This document also provides increasing the perceived contrast by using a luminance filter which exhibits oscillations.

Whatever the method used, the object is to obtain a colorization palette on a monochrome image, by following a color sequence, represented by sRGB triplets, and while respecting a number of rules defined based on specifications. Such specifications conventionally comprise both cognition and communication criteria, which criteria may be in contradiction.

Communication criteria concern the search for an aesthetic appearance, the compliance with a graphic charter or also the conformality to a specific evocative application, for example the desired color for representing animals in hunting images.

Cognition criteria aim, for example, at facilitating the interpretation of the image according to the type of scene, at improving the perception of the image contrast, at increasing the saliency on the type of objects of interest, or at facilitating the interpretation of the image for visually impaired persons, typically for color-blind persons.

In all cases, cognition criteria are different from one person to the other.

Now, existing solutions enable to design color palettes which are linear in absolute luminance, but they are not linear in terms of perception regarding the cognition criteria of a specific person. As a result, certain details of a colorized infrared image are not necessarily visible for a given person, while they may be by another person.

The technical problem of the invention thus is to obtain a method of colorization of an infrared image with a linear color palette according to a person's perception, so that a person can simply modify the color palette for a specific application and/or for a personal perception.

### SUMMARY OF THE DISCLOSURE

To address this technical problem, the invention provides using a color palette defined in the CIE CAM02-UCS space by a parametric trajectory. This uniform CIE CAM02-UCS colorimetric space is defined in the article by R. Luo, G. Cui and C. Li, “Uniform color spaces based on CIECAM02 color appearance model” Color Research and Application, 2006. In this Cartesian space of axes j*, a* and b*, j* corresponds to the perceived luminance, a* corresponds to the blue-to-yellow color axis and b* corresponds to the green-to-red color axis.

The chrominance is defined by the following equation:

c*=\sqrt{a*²+b*²}

The hue is defined by the following equation:

$${h}^{*} = a tan 2 ( \frac{{b}^{*}}{{a}^{*}} )$$

More specifically, the invention originates from an observation according to which, to obtain an efficient linearity in terms of perception, the parameter of this trajectory has to be the polar angle vector. According to this same observation, the trajectory projected into the hue and chrominance plane also need to follow one or two ellipses while the dynamic range of the perceived luminance with respect to the grayscale values needs to follow one or two straight lines.

With the invention, a user can use predefined mathematical definitions of this parametric trajectory for different applications and obtain a color palette which is linear in terms of perception regarding generic cognition criteria.

Further, the user may also adjust certain parameters of this parametric trajectory to adapt a generic cognition criterion to his/her own feeling.

Thus, the invention concerns a method of colorizing an infrared image comprising the following steps:
acquisition of an infrared image obtained from an infrared sensor comprising a set of elementary detectors, said infrared image comprising, for each elementary detector, a pixel having its value coded in grayscale corresponding to a value representing an infrared radiation received by said elementary detector; and
generation of a colorized image by associating with each pixel value coded in grayscale a pixel value coded in a color space by means of a color palette.

The invention is characterized in that said color palette is defined in the CIE CAM02-UCS space by a module for generating palettes using a parametric trajectory in which a parameter is formed by a polar angle vector of the parametric trajectory, the latter being defined so that:
the parametric trajectory projected into a hue and chrominance plane follows one or two ellipses; and
a dynamic range of the perceived luminance with respect to the grayscale values follows one or two straight lines.

Preferably, the parametric trajectory follows the following relation:

$$\{ \begin{matrix}{a}^{′} ( ϕ ) = {a}_{ell} ( cos ϕ - 1 ) \\ {b}^{′} ( ϕ ) = {b}_{ell} sin ϕ\end{matrix}$$

with a first half-axis (aₑₗₗ) corresponding to a peak chrominance (c_{c}*) divided by two, and with a second half-axis (bₑₗₗ) defined as a function of the first half-axis (aₑₗₗ) with:
bₑₗₗ=aₑₗₗ\sqrt{1−e²}; if an eccentricity (e) of the ellipse is positive; and

$${b}_{ell} = \frac{{a}_{ell}}{\sqrt{1 - {e}^{2}}} ;$$

if the eccentricity (e) of the ellipse is negative.

With these precise construction parameters, the invention enables to obtain a color palette linearly designed in the CIE CAM02-UCS space to guarantee a good luminance perception linearity.

The color palette thus defined can then be modified by a user according to his/her own expectations. For this purpose, the method may also comprise the following steps:
display of said colorized image on a screen visible by a user; and
recovery, from a man-machine interface, of the colorization modifications expected by the user.

Preferably, the man-machine interface enables to modify a peak hue, a peak chrominance, a dynamic range of the polar angle vector, an eccentricity of said at least one ellipse projected into the hue and chrominance plane, and/or a dynamic range of the perceived luminance. These parameters enable to modify a color palette with notions intelligible to those skilled in the art eager to improve image chromatography.

In the sense of the invention, the hue or chrominance peak refers to the point for which the polar angle corresponds to TT. In the case where the ellipticity is positive, this peak corresponds to a chrominance maximum.

Preferably, the dynamic range of the polar angle vector is limited between 0 and 2π or 2π and 0.

Further, to simplify the selection of a color palette for specific applications, said man-machine interface may also enable to select predefined palettes.

For example, to evoke the idea of thermal imaging, while avoiding inaesthetic violet hues and too aggressive white and yellow hues, a first predefined palette preferably has a peak hue in the range from 20 to 30°, a peak chrominance in the range from 30 to 40, a dynamic range of the polar angle vector in the range from 0 to 1.8π, an eccentricity of an ellipse projected into the hue and chrominance plane in the range from −0.35 to −0.25, and a dynamic range of the perceived luminance in the range from 5 to 100. This first predefined palette avoids pure white and too bright yellow for the representation of warm colors, to limit the aggression and visual fatigue effect.

For night vision applications, the green monochromatic representation of a night image takes as a reference the phosphorus scintillator used in light intensifier tubes, which has a spectral re-emission length centered on green. The use of green has become iconic and evocative to the general public of night imaging, since it is in particular conveyed by military propaganda, via movies and video games. The use of green also has advantages in terms of sensitivity to light, since the spectral sensitivity curve is maximum around 555 nanometers, at least in good luminosity conditions.

In this type of night vision applications, the display is generally set with a very low luminosity. This enables on the one hand to decrease the time of adaptation of the user's vision when they stop viewing the screen displaying the colorized infrared image to directly observe their environment; and on the other hand, this enables to decrease the light reflected on the face, for stealth reasons.

Now, in scotopic vision, the spectral sensitivity curve adapts to darkness, by involving rods rather than cones, it then is a scotopic vision having its sensitivity curve centered around 507 nanometers.

The second predefined palette is designed to ease the viewing of an infrared image in darkness conditions, while limiting visual fatigue in case of a prolonged viewing of a video stream. For this purpose, the second predefined palette has a peak hue in the range from −170 to −160°, a peak chrominance in the range from 10 to 20, a dynamic range of the polar angle vector in the range from 0 to 2π, an eccentricity of an ellipse projected into the hue and chrominance plane in the range from 0.2 to 0.4, and a dynamic range of the perceived luminance in the range from 100 to 20.

With this second predefined palette, the image seems to be smooth, round, while remaining sharp and saliant on the objects of interest. The background is displayed in light color, particularly for the sky, which decreases efforts both on the aperture of the pupil and on interpretation, particularly by familiarity with day scenes where the sky is clear. The aesthetic appearance of the colorized image provides a glossy paper printing appearance, which is considered rather pleasant.

A third predefined palette is formed by a threshold palette, that is, a palette which is constructed by concatenation of two palettes, with a grayscale threshold from which a transition between the two palettes is performed. Preferably, a color continuity is ensured at the level of said threshold. These two palettes enable to separate two families/classes of pixels by colorizing them differently, and by maximizing the dynamic range of the perceived luminance on each class. These two families/classes of pixels may differ by distinct hue or chrominances variations.

To bring out hot areas from the ambient temperature of a scene, by maximizing details on the two areas, the third predefined palette preferably comprises a first portion with a peak hue in the range from −110 to −100°, a peak chrominance in the range from 15 to 20, a dynamic range of polar angle vector in the range from 2π to 0, an eccentricity of a first ellipse projected into the hue and chrominance plane in the range from 0.5 to 0.7, and a dynamic range of the perceived luminance in the range from 100 to 5; and then a second portion with a peak hue in the range from 25 to 40°, a peak chrominance in the range from 30 to 40, a dynamic range of the polar angle vector in the range from 0 to 1.8π, an eccentricity of a second ellipse projected into the hue and chrominance plane in the range from 0.3 to 0.4, and a dynamic range of the perceived luminance in the range from 5 to 99, the threshold between the two portions being set between 45 and 55% of the grayscale values.

In this third predefined palette, the representation of the object of interest is achieved by a palette close to the first predefined palette, with the difference that the dynamic range of the hue is slightly reduced to avoid overloading the image.

Thus, the object of interest is normally colorized, which facilitates the interpretation of the nature of the image. The perceived luminance has a full increasing dynamic range to ensure the linearity of the color variation for the user.

The representation of the background is also performed via an elliptical palette, with a perceived luminance having a full decreasing dynamic range, and a slate blue peak. This peak color is selected with a low chrominance since it is desired to attract less attention to the background and more attention to the object of interest. Similarly, with this third predefined palette, it is desired to limit the hue variation via a highly-elliptic trajectory. These choices also result in decreasing the sensitivity to small intensity variations, partly limiting the perception of noise, the signal-to-noise ratio being generally lower on the ambient background than on the hot object of interest.

The decreasing perceived luminance enables to lighten the background to improve the saliency on the object of interest. This saliency is underlined by a black contour at the threshold, and by the chrominance contrast between the two classes of pixels. For this purpose, the pixels around the threshold are colorized with dark colors at low chrominance, typically colors close to black. These pixels are generally at the border between the background and the object of interest.

Finally, the use of blue for the representation of the background can be justified on the one hand since it a hue that evokes a cold temperature, and on the other hand since it is a color that evokes the sky, which is a reassuring representation for the human being. For this same reason, the use of blue causes an illusion of depth by reminding the horizon, it is at least a technique used by impressionists to produce this effect.

In a fourth predefined palette, it is desired to define a palette which comprises a grayscale section at full dynamic range of the perceived luminance and, from a hot threshold, a bright colorized section with red hues.

For hunting applications, hot spots are generally animals, which are desired to be brought out in the image. The environment is also very important in such an application. It is generally formed of complex elements such as vegetation, whereby the importance of representing it in full grayscale dynamic range. Other applications may need to alert the user, for example the ADAS, for “Advanced Driver Assistance System” application, consisting of alerting a driver on the presence of a pedestrian, for braking assistance.

For this purpose, the fourth predefined palette preferably has a first portion with a null chrominance and a dynamic range of the perceived luminance in the range from 0 to 100; and then a second portion with a peak hue in the range from 30 to 35°, a peak chrominance in the range from 30 to 40, a dynamic range of the polar angle vector in the range from 2π to 0, an eccentricity of an ellipse projected into the hue and chrominance plane in the range from 0.8 to 0.9, and a dynamic range of the perceived luminance in the range from 100 to 30, the threshold between the two portions being set between 75 and 85% of the grayscale values.

### BRIEF DESCRIPTION OF THE DRAWINGS

The way in which to implement the invention as well as the resulting advantages, will become apparent from the following embodiments, given as a non-limiting indication, in relation with FIGS. 1 to 7 in which:

FIG. 1 is a simplified representation of a method of colorizing an infrared image according to an embodiment of the invention;

FIG. 2 is a simplified representation of a parametric generation of a color palette according to the method of FIG. 1 with an ellipse projected into a hue and chrominance plane;

FIG. 3 illustrates three variations of a parametric generation of a color palette according to the method of FIG. 1 with an ellipse projected into the hue and chrominance plane according to the variation of the eccentricity of the ellipse;

FIG. 4 illustrates the dynamic range of the perceived luminance and of an ellipse projected in the hue and chrominance plane for a first predefined palette of the method of FIG. 1;

FIG. 5 illustrates the dynamic range of the perceived luminance and of an ellipse projected into the hue and chrominance plane for a second predefined palette of the method of FIG. 1;

FIG. 6 illustrates the dynamic range of the perceived luminance and two ellipses projected into the hue and chrominance plane for a third predefined palette of the method of FIG. 1; and

FIG. 7 illustrates the dynamic range of the perceived luminance and an ellipse projected into the hue and chrominance plane for a fourth predefined palette of the method of FIG. 1.

### DETAILED DESCRIPTION

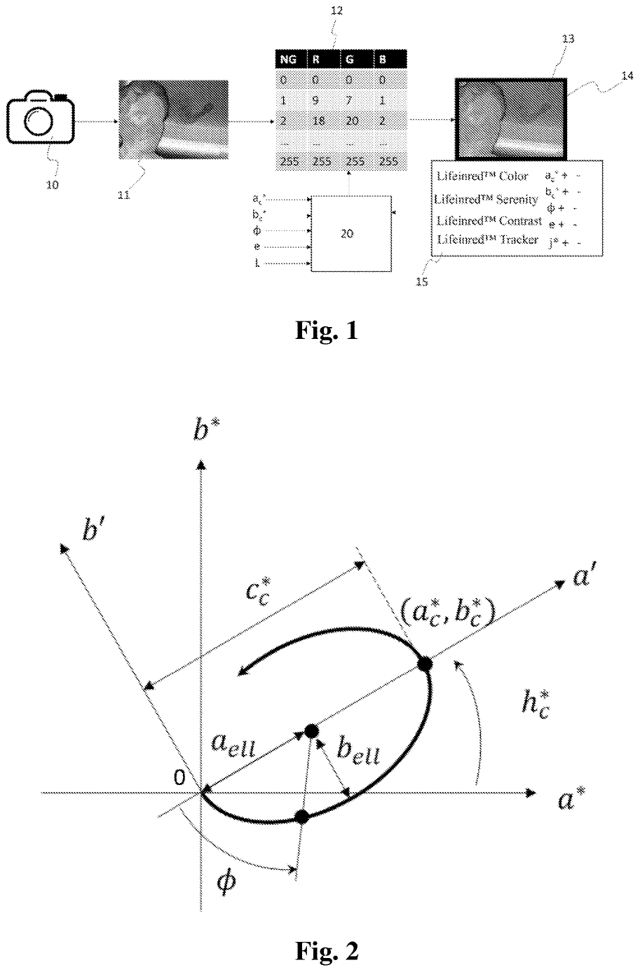

FIG. 1 illustrates a method of colorizing an infrared image 11 obtained from an infrared sensor 10 comprising a set of elementary detectors. Conventionally, the elementary detectors are formed of microbolometers arranged in an array.

For each row or for each column of microbolometers, a readout circuit enables to measure a quantity of infrared radiation captured by each elementary detector thus forming the pixels of an infrared image.

The values originating from each pixel of the infrared image may be coded in grayscale NG over 8, 11, or 14 bits without changing the invention. Further, preprocessings may be carried out on infrared image 11 before implementing the colorization method of the invention.

More specifically, the invention provides using a color palette 12 to transform the infrared image 11 coded in grayscale NG into a colorized image 13, each pixel of which is coded by a color system, for example according to the sRGB standard.

According to the invention, color palette 12 is defined in the CIE CAM02-UCS space, by defining each color by six features: luminosity, absolute luminance, colorization, chrominance c*, saturation, and hue h*. These six features are interdependent and may be coded by a triplet of three values: j*, a*, and b*, with parameter j* corresponding to the perceived luminance, a* corresponding to the blue-to-yellow color axis, and b* corresponding to the green-to-red color axis.

In this CIE CAM02-UCS space, the chrominance c* is defined by the following equation:

c*=\sqrt{a+²+b+²}

The hue h* is defined by the following equation:

$${h}^{*} = a tan 2 ( \frac{{b}^{*}}{{a}^{*}} )$$

More specifically, the invention provides the generation of color palette 12 in the CIE CAM02-UCS space by a palette generation module 20 using a parametric trajectory in which the parameter is a polar angle vector ¢. This parametric definition is constrained so that the trajectory projected into the hue and chrominance plane (O, a_{c}*, b_{c}*) follows one or two ellipses; and the dynamic range of the perceived luminance j* with respect to the grayscale values NG follows one or two straight lines.

FIG. 2 illustrates a representation of an ellipse in the hue and chrominance plane (O, a_{c}*, b_{c}*) of a parametric generation of a color palette 12. In this example, the ellipse is formulated according to a parametric trajectory, the parameter of which is the polar angle vector φ=[0, . . . , φ max] of length 2ⁿ, with n corresponding to the depth of the value of the digitized pixel. Thus, the various grayscale values NG are in the range from 0 to 2ⁿ⁻¹. Preferably, depth φmax=1.8π. Preferably, the dynamic range of polar angle vector Φ is limited between 0 and 2π or 2π and 0.

In the example of FIG. 2, the ellipse does not complete a full rotation, that is, it is not closed, to avoid ending the palette on pure white, which is considered aggressive.

The ellipse is defined according to the following equation:

$$\{ \begin{matrix}{a}^{′} ( ϕ ) = {a}_{ell} ( cos ϕ - 1 ) \\ {b}^{′} ( ϕ ) = {b}_{ell} sin ϕ\end{matrix}$$

in which the ellipse has a first half-axis aₑₗₗ corresponding to a peak chrominance c_{c}* divided by two, in the reference frame aligned on the axes of the ellipse (O, a′, b′), and the second half-axis bₑₗₗ depends on the first half-axis aₑₗₗ and on the eccentricity e of the ellipse.

More specifically, the second half-axis bₑₗₗ can be deduced from the desired eccentricity e, with the following equation, if the eccentricity is positive:

bₑₗₗ=aₑₗₗ\sqrt{1−e²}

When the eccentricity is negative, the second half-axis follows the following equation:

$${b}_{ell} = \frac{{a}_{ell}}{\sqrt{1 - {e}^{2}}}$$

When the eccentricity is positive, the first half-axis aₑₗₗ is larger than the second half-axis bₑₗₗ while the first half-axis aₑₗₗ is smaller than the second half-axis bₑₗₗ when the eccentricity is negative.

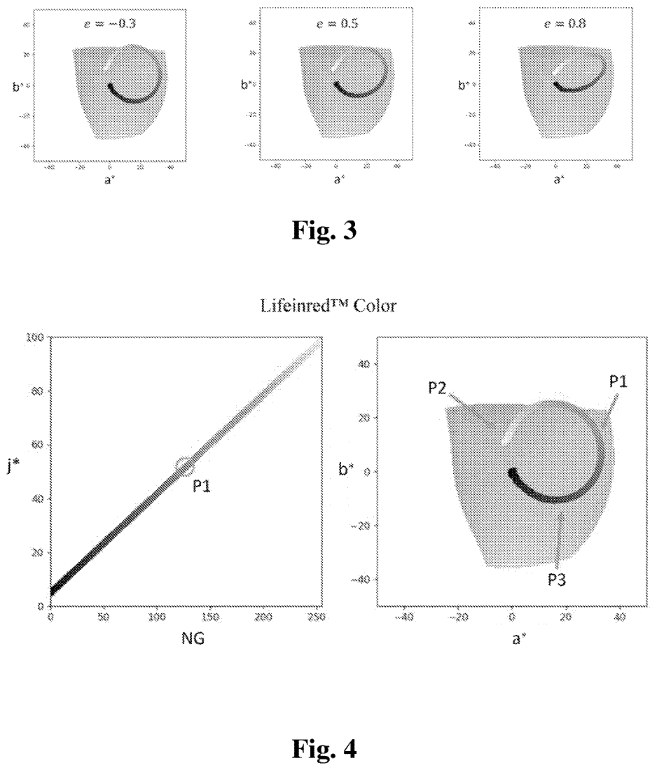

The impact of the variation of eccentricity e is illustrated in FIG. 3 in which a parametric trajectory with a small eccentricity enables to take advantage of purplish and orange hues, while a parametric trajectory with a high eccentricity avoids such hues, at the risk of giving the image a monochrome appearance.

For cosmetic reasons and to facilitate the perception of details via a good dynamic range of purplish/orange hues, it is preferable to select a low eccentricity, typically an eccentricity in the range from −0.2 to −0.4, for example e=−0.3.

Whatever the selected eccentricity value, it is possible to perform a change of reference frame to write the ellipse in the reference frame (O, a, b*) of FIG. 2 by simple azimuthal rotation of angle h_{c}*, that is, by the hue of the desired peak, according to the following equation:

$$\{ \begin{matrix}a ( ϕ ) = {a}^{′} ( ϕ ) cos {h}_{c}^{*} - {b}^{′} ( ϕ ) sin {h}_{c}^{*} \\ b ( ϕ ) = {a}^{′} ( ϕ ) sin {h}_{c}^{*} + {b}^{′} ( ϕ ) cos {h}_{c}^{*}\end{matrix}$$

The peak hue angle can be written as h_{c}*=atan2(b_{c}*, a_{c}*) and the perceived luminance curve j* (φ) is simply a straight line, the limits of the dynamic range of which can be set. The values of peak hue h_{c}*, of peak chrominance c_{c}*, of dynamic range of the polar angle vector Φ, of eccentricity e, and/or a dynamic range of the perceived luminance j*, may be selected according to the typology of the desired color palette. For example, it is possible to increase the hue dynamic range by decreasing the eccentricity e of the ellipse.

With these precise parameters of definition of color palette 12, it is possible to obtain a table associating with each grayscale value NG a triplet in the sRGB space. For example, this conversion between the CIE CAM02-UCS space and the sRGB space may be performed by the “colorspacious” module, coded in Python computer language. This table may be called LUT, for “Look Up Table”.

In this color palette 12, each grayscale value NG is thus associated with a color triplet in the sRGB space so that infrared image 11 can be transformed into a colorized image 13. Colorized image 13 can then be displayed on a screen 14 so that a user can efficiently detect the salient elements of a scene captured by an infrared sensor 10.

To detect specific elements in various applications, the user can use a man-machine interface 15 to select predefined color palettes.

Further, man-machine interface 15 may also enable the user to adjust the construction values of color palette 12.

Indeed, even if color palette 12 is defined with values of peak hue h_{c}*, of peak chrominance c_{c}*, of dynamic range of polar angle vector Φ, of eccentricity e, and/or a dynamic range of the perceived luminance j*, the user may possibly change these values via man-machine interface 15. For this purpose, the user may request an incrementation or a decrease of each value to observe the evolution of these variations directly on the screen 14 for viewing colorized image 13.

As concerns the predefined color palettes, four palettes may be offered to the user via man-machine interface 15: Lifeinred™ Color, Lifeinred™ Serenity, Lifeinred™ Contrast, and Lifeinred™ Tracker.

For example, predefined palette Lifeinred™ Color has a peak hue h_{c}* in the range from 20 to 30°, a peak chrominance c_{c}* in the range from 30 to 40, a dynamic range of polar angle vector @ in the range from 0 to 1.8π, an eccentricity e of an ellipse projected into the hue and chrominance plane (O, a*, b*) in the range from −0.35 to −0.25, and a dynamic range of the perceived luminance j* in the range from 5 to 100.

As illustrated in FIG. 4, this predefined palette Lifeinred™ Color comprises a straight and increasing dynamic range of the perceived luminance j* and an ellipse in the hue and chrominance plane (O, a*, b*). Point P1 corresponds to a coral-red color, point P2 corresponds to a vanilla or peach color, and point P3 corresponds to a burgundy color.

Predefined palette Lifeinred™ Serenity has a peak hue h_{c}* in the range from −170 to −160°, a peak chrominance c_{c}* in the range from 10 to 20, a dynamic range of polar angle vector Φ in the range from 0 to 2π, an eccentricity e of an ellipse projected into the hue and chrominance plane (O, a*, b*) in the range from 0.2 to 0.4, and a dynamic range of the perceived luminance j* in the range from 100 to 20.

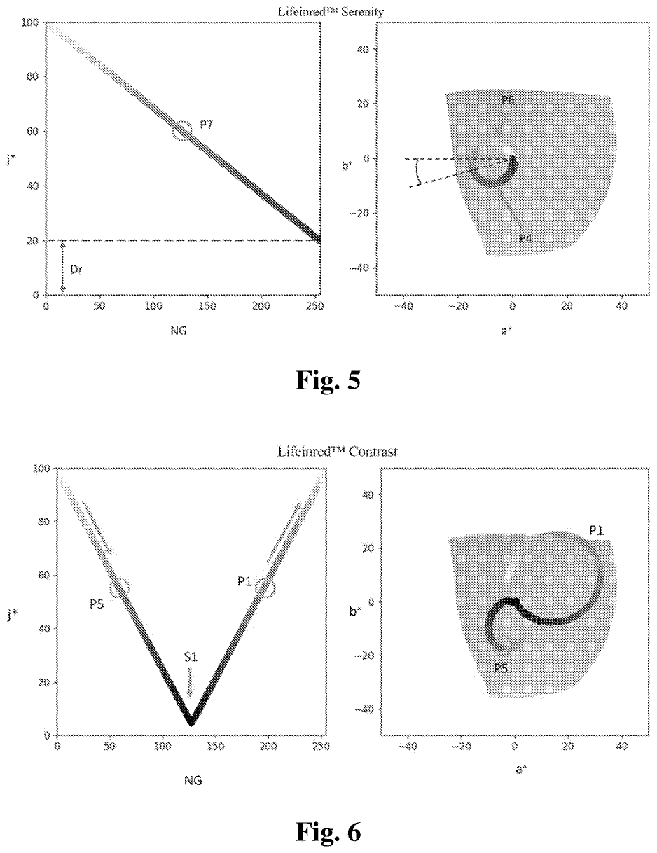

As illustrated in FIG. 5, this predefined palette Lifeinred™ Serenity comprises a straight and decreasing dynamic range of the perceived luminance j* with a reduced dynamic range Dr and an ellipse in the hue and chrominance plane (O, a*, b*). Point P6 corresponds to a water-green color, while point P5 corresponds to a slate grey color and point P7 corresponds to the teal-blue color.

Predefined palette Lifeinred™ Contrast has a first portion with peak hue h_{c}* in the range from −110 to −100°, a peak chrominance c_{c}* in the range from 15 to 20, a dynamic range of polar angle vector Φ in the range from 2π to 0, an eccentricity e of a first ellipse projected into plane (O, a*, b*) in the range from 0.5 to 0.7, and a dynamic range of the perceived luminance j* in the range from 100 to 5.

Predefined palette Lifeinred™ Contrast also has a second portion with peak hue h_{c}* in the range from 25 to 40°, a peak chrominance c_{c}* in the range from 30 to 40, a dynamic range of polar angle vector Φ in the range from 0 to 1.8π, an eccentricity e of a second ellipse projected into plane (O, a*, b*) in the range from 0.3 to 0.4, and a dynamic range of the perceived luminance j* in the range from 5 to 100. The threshold S1 between the two portions is set between 45 and 55% of the grayscale values NG, for example 50%.

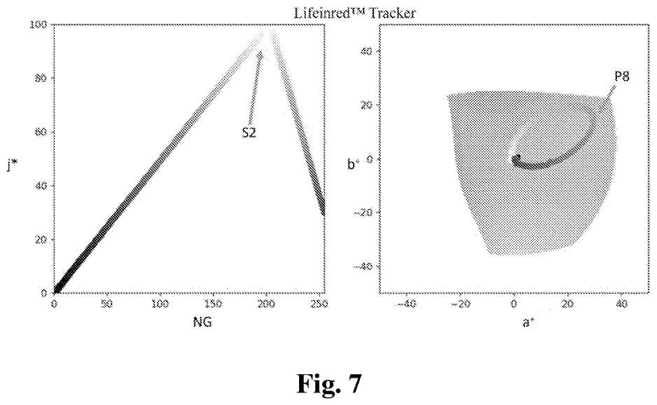

As illustrated in FIG. 6, this predefined palette Lifeinred™ Contrast comprises a straight dynamic range of the perceived luminance j* decreasing down to threshold S1 and then a straight and increasing dynamic range of the perceived luminance j*. Two ellipses are formed in plane (O, a*, b*). Point P1 corresponds to a coral-red color, also used for predefined palette Lifeinred™ Color, while point P5 corresponds to the slate blue color.

Predefined palette Lifeinred™ Tracker has a first portion with a null chrominance and a dynamic range of the perceived luminance j* in the range from 0 and 100; and then, a second portion with a peak hue h_{c}* in the range from 30 to 35°, a peak chrominance c_{c}* in the range from 30 to 40, a dynamic range of polar angle vector Φ in the range from 2π to 0, an eccentricity e of an ellipse projected into plane (O, a*, b*) in the range from 0.8 to 0.9, and a dynamic range of the perceived luminance j* in the range from 100 to 30. The threshold S2 between the two portions being set between 75 and 85% of grayscale values NG, for example 80%.

As illustrated in FIG. 7, this predefined palette Lifeinred™ Tracker comprises a straight dynamic range of the perceived luminance j* increasing up to threshold S2 and then a straight and decreasing dynamic range of the perceived luminance j*. An ellipse is formed in plane ab, in which point P8 corresponds to a red brick color.

With these various predefined color palettes and man-machine interface 15 enabling the user to modify the parameters of generation of color palette 12, the invention enables a user to obtain a linear aspect according to his/her personal perception. The invention thus enables to more distinctly observe the objects of interest captured by an infrared detector.

1. A method of colorizing an infrared image comprising the following steps:
acquisition of an infrared image obtained from an infrared sensor comprising a set of elementary detectors, said infrared image comprising, for each elementary detector, a pixel having its value coded in grayscale corresponding to a value representing an infrared radiation received by said elementary detector; and
generation of a colorized image by associating to each pixel value coded in grayscale a pixel value coded in a color space by means of a color palette;
wherein said color palette is defined in the CIE CAM02-UCS space by a module for generating palettes using a parametric trajectory in which a parameter is a polar angle vector (Φ) of the parametric trajectory, the latter being defined so that:
the parametric trajectory projected into a hue and chrominance plane (O, a*, b*) follows one or two ellipses; and
a dynamic range of the perceived luminance (j*) with respect to the grayscale values follows one or two straight lines.

2. The method of colorizing an infrared image according to claim 1, wherein the parametric trajectory follows the following relation:
$$\{ \begin{matrix}{a}^{′} ( ϕ ) = {a}_{ell} ( cos ϕ - 1 ) \\ {b}^{′} ( ϕ ) = {b}_{ell} sin ϕ\end{matrix}$$
with a first half-axis (aₑₗₗ) corresponding to a peak chrominance (c_{c}*) divided by two, and a second half-axis (bₑₗₗ) defined as a function of the first half-axis (aₑₗₗ) with:
bₑₗₗ=aₑₗₗ\sqrt{1−e²}; if an eccentricity (e) of the ellipse is positive; and
$${b}_{ell} = \frac{{a}_{ell}}{\sqrt{1 - {e}^{2}}} ;$$
in the eccentricity (e) of the ellipse is negative.

3. The method of colorizing an infrared image according to claim 1, wherein the method also comprises the following steps:
display of said colorized image on a screen visible by a user; and
recovery, from a man-machine interface, of the colorization changes expected by the user.

4. The method of colorizing an infrared image according to claim 3, wherein the man-machine interface enables to modify a peak hue (h_{c}*), a peak chrominance (c_{c}*), a dynamic range of the polar angle vector (Φ), an eccentricity (e) of the at least one ellipse projected into the hue and chrominance plane (O, a*, b*), and/or a dynamic range of the perceived luminance (j*).

5. The method of colorizing an infrared image according to claim 1, wherein the dynamic range of the polar angle vector (Φ) is limited between 0 and 2π or 2π and 0.

6. The method of colorizing an infrared image according to claim 3, wherein said man-machine interface enables to select predefined palettes.

7. The method of colorizing an infrared image according to claim 6, wherein a first predefined palette (Lifeinred™ Color) has a peak hue (h_{c}*) in the range from 20 to 30°, a peak chrominance (c_{c}*) in the range from 30 to 40, a dynamic range of the polar angle vector (Φ) in the range from 0 to 1.8π, an eccentricity (e) of an ellipse projected into the hue and chrominance plane (O, a*, b*) in the range from −0.35 to −0.25, and a dynamic range of the perceived luminance (j*) in the range from 5 to 100.

8. The method of colorizing an infrared image according to claim 6, wherein a second predefined palette (Lifeinred™ Serenity) has a peak hue (h_{c}*) in the range from −170 to −160°, a peak chrominance (c_{c}*) in the range from 10 to 20, a dynamic range of the polar angle vector (Φ) in the range from 0 to 2π, an eccentricity (e) of an ellipse projected into the hue and chrominance plane (O, a, b*) in the range from 0.2 to 0.4, and a dynamic range of the perceived luminance (j*) in the range from 100 to 20.

9. The method of colorizing an infrared image according to claim 6, wherein a third predefined palette (Lifeinred™ Contrast) has a first portion with peak hue (h_{c}*) in the range from −110 to −100°, a peak chrominance (c_{c}*) in the range from 15 to 20, a dynamic range of the polar angle vector (Φ) in the range from 2π to 0, an eccentricity (e) of a first ellipse projected into the hue and chrominance plane (O, a*, b*) in the range from 0.5 to 0.7, and a dynamic range of the perceived luminance (j*) in the range from 100 to 5; then a second portion with a peak hue (h_{c}*) in the range from 25 to 40°, a peak chrominance (c_{c}*) in the range from 30 to 40, a dynamic range of the polar angle vector (Φ) in the range from 0 to 1.8®, an eccentricity (e) of a second ellipse projected into the hue and chrominance plane (O, a, b*) in the range from 0.3 to 0.4, and a dynamic range of the perceived luminance (j*) in the range from 5 to 100, the threshold between the two portions being set between 45 and 55% of the grayscale values.

10. The method of colorizing an infrared image according to claim 6, wherein a fourth predefined palette (Lifeinred™ Tracker) has a first portion with a null chrominance and a dynamic range of the perceived luminance (j*) in the range from 0 to 100; and then a second portion with a peak hue (h_{c}*) in the range from 30 to 35°, a peak chrominance (c_{c}*) in the range from 30 to 40, a dynamic range of the polar angle vector (Φ) in the range from 2π to 0, an eccentricity (e) of an ellipse projected into the hue and chrominance plane (O, a, b*) in the range from 0.8 to 0.9, and a dynamic range of the perceived luminance (j*) in the range from 100 to 30, the threshold between the two portions being set between 75 and 85% of the grayscale values.
